(19) United States
(12) Patent Application Publication
(10) Pub. No.: US 2025/0047344 A1
(43) Pub. Date: Feb. 6, 2025

(54) COMMUNICATION METHOD AND APPARATUS, AND ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/709,127

(22) PCT Filed: Nov. 15, 2021
(86) PCT No.: PCT/CN2021/130714

§ 371 Date: May 10, 2024

(51) Int. Cl. H04B 7/06; H04B 17/20; H04L 65/1066

(52) U.S. Cl. CPC H04B 7/0626; H04B 17/25; H04L 65/1066

(57) ABSTRACT

A communication method includes: determining a target radio frame, the target radio frame including a channel state information (CSI) threshold, and the CSI threshold being configured for a responder to send a CSI measurement value to an initiator according to the CSI threshold; and sending the target radio frame.

### CROSS REFERENCE TO RELATED APPLICATIONS

The present disclosure is the U.S. national phase application of International Application No. PCT/CN2021/130714 filed on Nov. 15, 2021, the content of which is incorporated herein by reference in its entirety for all purposes.

### TECHNICAL FIELD

The present disclosure relates to the field of mobile communication technology, in particular to a communication method and an apparatus thereof, an electronic device, and a storage medium.

### BACKGROUND

With the rapid development of mobile communication technology, wireless fidelity (Wi-Fi) technology has made tremendous progress in transmission speed and throughput. At present, the research on Wi-Fi technology includes, for example, transmission in the 320 MHz bandwidth, aggregation and collaboration of multiple frequency bands, etc. Main application scenarios for Wi-Fi technology include, for example, video transmission, augmented reality (AR), virtual reality (VR), etc.

### SUMMARY

On one aspect, the present disclosure provides a communication method, which is performed by an initiator and includes: determining a target radio frame, wherein the target radio frame includes a Channel State Information (CSI) threshold, and the CSI threshold is configured for a responder to send a CSI measurement value to the initiator based on the CSI threshold; and sending the target radio frame.

On another aspect, the present disclosure provides a communication method, which is performed by a responder and includes: receiving a target radio frame to obtain a Channel State Information (CSI) threshold carried in the target radio frame; and performing a processing operation based on a CSI variation and the CSI threshold.

On another aspect, the present disclosure provides a communication apparatus, which is applied to an initiator and includes: a determination module configured to determine a target radio frame, wherein the target radio frame includes a Channel State Information (CSI) threshold, and the CSI threshold is configured for a responder to send a CSI measurement value to the initiator based on the CSI threshold; and a sending module configured to send the target radio frame.

On another aspect, the present disclosure provides a communication apparatus, which is applied to a responder and includes: a receiving module configured to receive a target radio frame to obtain a Channel State Information (CSI) threshold carried in the target radio frame; and a processing module configured to perform a processing operation based on a CSI variation and the CSI threshold.

The present disclosure also provides an electronic device including a memory, a processor, and a computer program stored on the memory and executable by the processor. The processor executes the program to implement the methods as described in one or more embodiments of the present disclosure.

The present disclosure also provides a computer-readable storage medium having a computer program stored thereon. When the computer program is executed by a processor, the methods as described in one or more embodiments of the present disclosure are caused to be implemented.

The additional aspects and advantages of embodiments of the present disclosure will be partially provided in the following description, which will become apparent from the following description or will be understood through practice of the present disclosure.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a flowchart of a communication method according to embodiments of the present disclosure;

FIG. 2 is a schematic diagram of a WLAN sensing architecture according to embodiments of the present disclosure;

FIG. 3 is a schematic diagram of a WLAN sensing architecture according to embodiments of the present disclosure;

FIG. 4 is a schematic diagram of a WLAN sensing architecture according to embodiments of the present disclosure;

FIG. 5 is a schematic diagram of a WLAN sensing procedure according to embodiments of the present disclosure;

FIG. 6 is a flowchart of a communication method according to embodiments of the present disclosure;

FIG. 7 is a schematic diagram of a structure of a communication apparatus according to embodiments of the present disclosure;

FIG. 8 is a schematic diagram of a structure of a communication apparatus according to embodiments of the present disclosure; and

FIG. 9 is a schematic diagram of a structure of an electronic device according to embodiments of the present disclosure.

### DETAILED DESCRIPTION

The term “and/or” in embodiments of the present disclosure describes the association relationship between associated objects, indicating that there can be three kinds of relationships. A and/or B, for example, can indicate the presence of A alone, the presence of A and B simultaneously, and the presence of B alone. The character “/” generally indicates that associated objects have an “or” relationship between them.

The term “multiple” in embodiments of the present disclosure refers to two or more, other quantifiers are similar to this.

A detailed explanation of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of the present disclosure as detailed in the appended claims.

The terms used in embodiments of the present disclosure are for the purpose of description of specific embodiments only, and are not intended to limit the embodiments of the present disclosure. Singular forms such as “a”, “said”, and “the” used in embodiments of the present disclosure and the appended claims are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

A clear and complete description of technical solutions disclosed in the embodiments of the present disclosure will be provided in the following, in conjunction with the drawings. Obviously, the embodiments described are only a part of disclosed embodiments of the present disclosure and not all of them. Based on the embodiments of the present disclosure, all other embodiments obtained by those of ordinary skill in the art without creative efforts fall within the protection scope of the present disclosure.

In the current research on Wi-Fi technology, wireless local area network (WLAN) sensing technology may be supported. For example, application scenarios such as location discovery, proximity detection, and presence detection in dense environments such as home and business environments. In the WLAN sensing procedure, it is necessary to provide a method to indicate the Channel State Information (CSI) threshold, to instruct the sensing receiver (responder) to perform the sensing measurement based on the CSI threshold.

Embodiments of the present disclosure provide a communication method and an apparatus thereof, an electronic device and a storage medium, to provide a method for indicating a CSI threshold in the wireless local area network sensing measurement process.

In some embodiments, the method and the apparatus are based on the same inventive concept. Due to the similar principles of solving problems by the method and by the apparatus, reference can be made between embodiments of the apparatus and the method, and the same will not be repeated.

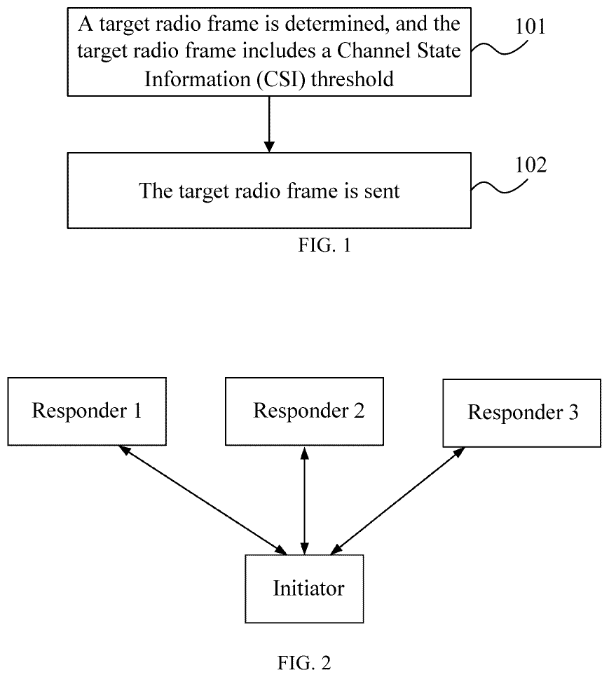

As shown in FIG. 1, embodiments of the present disclosure provide a communication method, which can be applied to a network device. The network device serves as a sensing initiator, which can be a sensing transmitter or a device that does not participate in the wireless local area network sensing measurement process.

The method can include the following steps.

In step 101, a target radio frame is determined. The target radio frame includes a Channel State Information (CSI) threshold, and the CSI threshold is configured for a responder to send a CSI measurement value to an initiator based on the CSI threshold.

In some embodiments, as shown in FIGS. 2 to 4, a WLAN sensing architecture and a WLAN sensing procedure in which the communication method provided in embodiments of the present disclosure is applied are first introduced.

FIG. 2 shows a schematic diagram of a WLAN sensing architecture. The sensing initiator initiates the WLAN sensing (for example, initiating a WLAN sensing session), and there may be multiple sensing responders (or sensing receivers) responding to the WLAN sensing, as is shown by Responder 1, Responder 2, and Responder 3 in FIG. 2. The responder is the receiver that receives a null data packet (NDP) measurement frame sent by a sender. When the sensing initiator initiates the WLAN sensing, multiple sensing responders associated or not associated with the WLAN sensing can respond. As shown in FIG. 2, Responder 1, Responder 2, and Responder 3 can each have an associated or unassociated relationship with the initiator. In some embodiments, “associated” can refer that an association connection for the communication between the sensing initiator and the sensing responder is established, and “unassociated” can refer that the association connection for the communication between the sensing initiator and the sensing responder is not established.

As shown in FIG. 3, the sensing initiator communicates with the sensing responder through a link, as shown by a link S1, and the communication between the sensing responders is carried out through a link S2.

In some embodiments, each sensing initiator can be a client, and each sensing responder (for example, the sensing Responder 1 to the sensing Responder 3) can be a station (STA). The STA can assume multiple roles in the WLAN sensing procedure. For example, in the WLAN sensing procedure, the sensing initiator may be a sensing transmitter, a sensing receiver, or both, or neither. In the WLAN sensing procedure, the sensing responder may also be a sensing transmitter, a sensing receiver, or both.

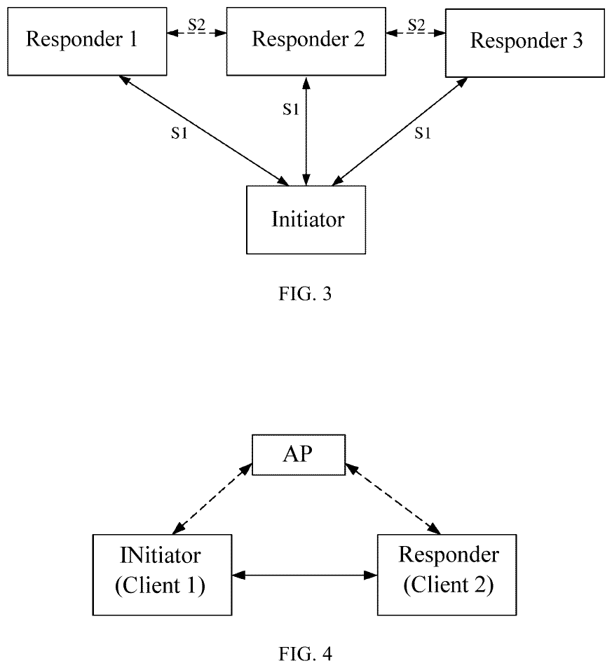

Another architecture is shown in FIG. 4, the sensing initiator and the sensing responder can be both clients, and the two can be connected to the same AP for communication. In FIG. 4, Client 1 is the sensing initiator and Client 2 is the sensing responder.

In the WLAN sensing procedure, the initiator determines the target radio frame and carries the CSI threshold in the target radio frame. The CSI threshold is the threshold for measuring the CSI variation in the channel. The CSI variation refers to the difference between the currently measured CSI and the previously measured CSI. The CSI threshold is configured for the responder to send the CSI measurement value to the initiator based on the CSI threshold. After receiving the target radio frame, the responder obtains the CSI threshold in the target radio frame and determines, based on the data relationship between the current CSI variation and the CSI threshold, whether to report CSI to the initiator. In some embodiments, if the current CSI variation does not exceed the CSI threshold, the responder may not report CSI, thereby saving signaling messages.

In some embodiments, the target radio frame can be a trigger frame or a message frame in the sensing measurement process. The CSI threshold can come from an upper layer application, for example, the CSI threshold is directly indicated to the initiator by the upper layer.

In step 102, the target radio frame is sent.

The initiator sends the target radio frame to the responder, so that the responder can determine, based on the CSI threshold in the target radio frame, whether to report CSI.

According to embodiments of the present disclosure, the initiator determines the target radio frame and sends the target radio frame to the responder. The target radio frame includes the Channel State Information (CSI) threshold, which is configured for the responder to determine, based on the CSI threshold, whether to send the CSI measurement value to the initiator. Embodiments of the present disclosure provide a method for indicating the CSI threshold in the WLAN sensing procedure.

In some embodiments, the target radio frame includes at least one of a trigger frame, a message frame for sensing session establishment, and a message frame for sensing measurement establishment.

The target radio frame can be the trigger frame, which is mainly configured for scheduling stations and allocating resource units (RU). In some embodiments, in the transmission mechanism based on Orthogonal Frequency Division Multiple Access (OFDMA) technology, the uplink transmission (UL-OFDMA) or the downlink transmission (DL-OFDMA) requires the use of the trigger frame to exchange scheduling information between multi-user communications.

The target radio frame can also be the message frame for sensing session establishment and the message frame for sensing measurement establishment. In some embodiments, the message frame for sensing session establishment is also known as the message frame for WLAN sensing session establishment, which is configured for establishing the sensing measurement session. The message frame for sensing measurement establishment is also known as the message frame for WLAN sensing measurement establishment, which is configured for establishing the sensing measurement process.

In some embodiments, in the uplink sensing measurement, the target radio frame can be the trigger frame, and in the downlink sensing measurement, the target radio frame can be either the message frame for sensing session establishment or the message frame for sensing measurement establishment.

In some embodiments of the present disclosure, the CSI threshold includes a first CSI threshold corresponding to a sensing session, or a second CSI threshold corresponding to a measurement process, or a third CSI threshold corresponding to a measurement instance.

The CSI threshold can be set to be at a sensing session level. That is, each sensing session corresponds to one CSI threshold, which is the first CSI threshold. In some embodiments, each sensing session includes multiple measurement processes. In the same sensing session, for each measurement process, the thresholds used by the responders involved in the measurement process are the same, i.e., the first CSI threshold corresponding to the sensing session.

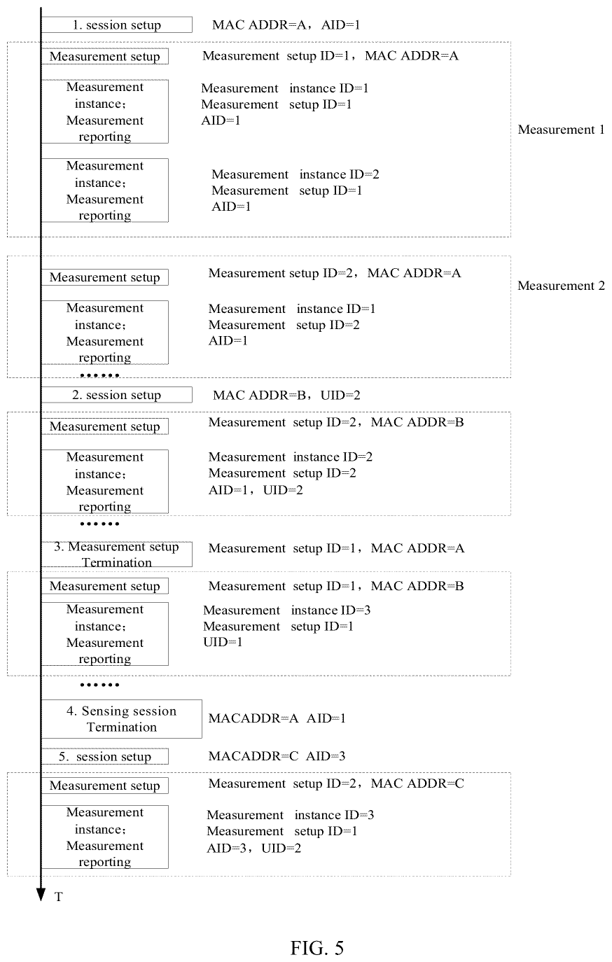

As shown in FIG. 5, a WLAN sensing procedure is illustrated, where T represents a time axis, AID represents an association identifier, and UID represents a user identifier. FIG. 5 includes multiple sensing session establishment processes, for example, “1. session setup”, “2. session setup”, and “5. session setup”. That “1. session setup” is taken as an example, where the Media Access Control (MAC) of the sensing session (hereinafter referred to as Sensing Session 1) has an address (ADDR) of A, and an AID of 1. The Sensing Session 1 includes two measurement processes, namely Measurement 1 and Measurement 2. In this way, the thresholds used by the responders involved in the processes Measurement 1 and Measurement 2 are the first CSI threshold.

The CSI threshold can also be set as the second CSI threshold corresponding to the measurement process. That is, the CSI threshold is included in the measurement process. In some embodiments, a specific measurement process includes multiple sensing measurement instances, and the CSI thresholds used for each measurement instance are the same, all of which are the second CSI threshold corresponding to this measurement process. All measurement instances under each measurement ID correspond to the same CSI threshold. As shown in FIG. 5, Measurement 1 in Sensing Session 1 includes two measurement instances, namely Measurement instance ID=1 and Measurement instance ID=2. The CSI thresholds corresponding to these two measurement instances are both the second CSI threshold corresponding to the measurement process.

The CSI threshold can also be set as the third CSI threshold corresponding to the measurement instance. That is, the CSI threshold is at a measurement instance level. Each measurement ID contains multiple measurement instances, and each instance corresponds to one CSI threshold. That is, each combination of Measurement ID and Measurement instance ID corresponds to one CSI threshold. As shown in FIG. 5, Measurement 1 in Sensing Session 1 includes two measurement instances, namely Measurement instance ID=1 and Measurement instance ID=2, and these two measurement instances each has one third CSI threshold. Therefore, the CSI thresholds used by the responders involved in each measurement instance are the third CSI threshold corresponding to this measurement instance.

In some embodiments, in case that the CSI threshold includes the first CSI threshold, the target radio frame includes the message frame for sensing session establishment, i.e., the message frame for WLAN sensing session establishment (sensing session setup). The message frame for WLAN sensing session establishment carries the first CSI threshold indicating the CSI thresholds used by responders involved in each measurement process under this sensing session.

In some embodiments, in case that the CSI threshold includes the second CSI threshold, the target radio frame includes the message frame for sensing session establishment.

In the message frame for sensing session establishment, the second CSI threshold corresponds to a measurement process identifier. In some embodiments, the message frame for sensing session establishment can include multiple measurement processes, and each measurement process has one second CSI threshold.

In some embodiments, in case that the CSI threshold includes the third CSI threshold, the target radio frame includes the message frame for sensing measurement establishment (measurement setup).

In the message frame for sensing measurement establishment, the third CSI threshold corresponds to the identifier combination of the measurement process identifier and the measurement instance identifier. That is, the CSI threshold is at a measurement instance level. Each measurement ID contains multiple measurement instances, and each measurement instance corresponds to one CSI threshold. In the message frame for sensing measurement establishment, each combination of Measurement ID and Measurement instance ID corresponds to one CSI threshold.

In some embodiments, after the target radio frame is sent, the method further includes following steps.

A CSI measurement value sent by the responder is received. The CSI measurement value is sent by the responder to the initiator, in response to the measured CSI variation exceeding the CSI threshold. The responder determines, based on the CSI threshold in the target radio frame and the CSI variation, whether to report CSI. If the CSI variation does not exceed the CSI threshold, CSI will not be reported, thereby saving signaling messages.

According to embodiments of the present disclosure, the initiator determines the target radio frame and sends the target radio frame to the responder. The target radio frame includes the Channel State Information (CSI) threshold, which is configured for the responder to determine, based on the CSI threshold, whether to send the CSI measurement value to the initiator. Embodiments of the present disclosure provide a method for indicating the CSI threshold in the WLAN sensing procedure.

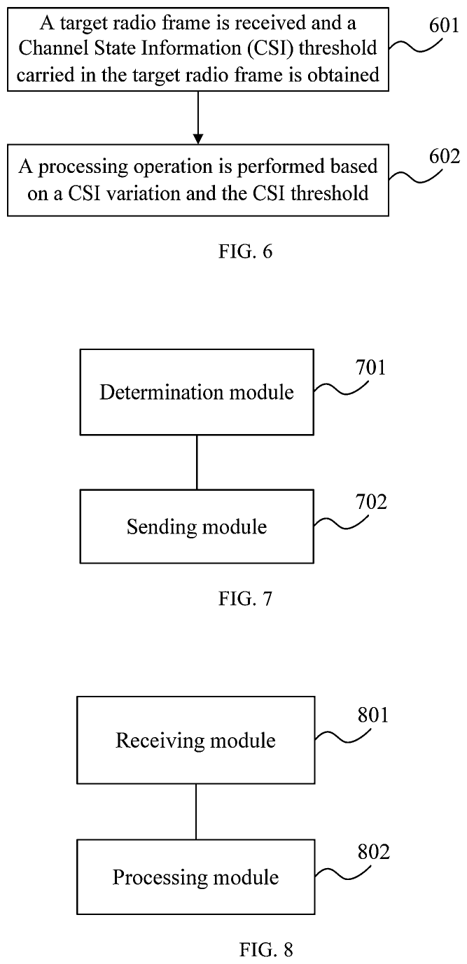

As shown in FIG. 6, embodiments of the present disclosure also provide a communication method, which can be applied to a responder (i.e., the sensing responder). The method can include the following steps.

In step 601, a target radio frame is received and a Channel State Information (CSI) threshold carried in the target radio frame is obtained.

In some embodiments, as shown in FIGS. 2 to 4, a WLAN sensing architecture and a WLAN sensing procedure in which the communication method provided in embodiments of the present disclosure is applied are first introduced.

FIG. 2 shows a schematic diagram of a WLAN sensing architecture. The sensing initiator initiates the WLAN sensing (for example, initiating a WLAN sensing session), and there may be multiple sensing responders (or sensing receivers) responding to the WLAN sensing, as is shown by Responder 1, Responder 2, and Responder 3 in FIG. 2. When the sensing initiator initiates the WLAN sensing, multiple sensing responders associated or not associated with the WLAN sensing can respond. As shown in FIG. 2, Responder 1, Responder 2, and Responder 3 can each have an associated or unassociated relationship with the initiator. In some embodiments, “associated” can refer that an association connection for the communication between the sensing initiator and the sensing responder is established, and “unassociated” can refer that the association connection for the communication between the sensing initiator and the sensing responder is not established.

As shown in FIG. 3, the sensing initiator communicates with the sensing responder through a link, as shown by a link S1, and the communication between the sensing responders is carried out through a link S2.

In some embodiments, each sensing initiator can be a client, and each sensing responder (for example, the sensing Responder 1 to the sensing Responder 3) can be a station (STA). The STA can assume multiple roles in the WLAN sensing procedure. For example, in the WLAN sensing procedure, the sensing initiator may be a sensing transmitter, a sensing receiver, or both, or neither. In the WLAN sensing procedure, the sensing responder may also be a sensing transmitter, a sensing receiver, or both.

Another architecture is shown in FIG. 4, the sensing initiator and the sensing responder can be both clients, and the two can be connected to the same AP for communication. In FIG. 4, Client 1 is the sensing initiator and Client 2 is the sensing responder.

In the WLAN sensing procedure, the responder receives the target radio frame and obtains the CSI threshold carried in the target radio frame. The CSI threshold is the threshold for measuring the CSI variation in the channel. The CSI variation refers to the difference between the currently measured CSI and the previously measured CSI. The CSI threshold is configured for the responder to send the CSI measurement value to the initiator based on the CSI threshold. After receiving the target radio frame, the responder obtains the CSI threshold in the target radio frame.

In step 602, a processing operation is performed based on a CSI variation and the CSI threshold.

After obtaining the CSI threshold, the responder determines, based on the data relationship between the current CSI variation and the CSI threshold, whether to report the CSI measurement value to the initiator. In some embodiments, if the current CSI variation does not exceed the CSI threshold, the responder may not report CSI, thereby saving signaling messages. In response to the measured CSI variation exceeding the CSI threshold, the responder sends the CSI measurement value to the initiator.

In some embodiments, the target radio frame includes at least one of a trigger frame, a message frame for sensing session establishment, and a message frame for sensing measurement establishment.

In some embodiments of the present disclosure, the CSI threshold includes a first CSI threshold corresponding to a sensing session, or a second CSI threshold corresponding to a measurement process, or a third CSI threshold corresponding to a measurement instance.

In some embodiments, in case that the CSI threshold includes the first CSI threshold, the target radio frame includes the message frame for sensing session establishment.

In some embodiments, in case that the CSI threshold includes the second CSI threshold, the target radio frame includes the message frame for sensing session establishment.

In the message frame for sensing session establishment, the second CSI threshold corresponds to a measurement process identifier.

In some embodiments, in case that the CSI threshold includes the third CSI threshold, the target radio frame includes the message frame for sensing measurement establishment.

In the message frame for sensing measurement establishment, the third CSI threshold corresponds to the combination of the measurement process identifier and the measurement instance identifier.

In some embodiments, performing the processing operation based on the CSI variation and the CSI threshold includes following steps:
a null data packet (NDP) sent by the initiator is received, the CSI is measured, and the CSI variation is determined;
the CSI measurement value is sent to the initiator in response to the CSI variation exceeding the CSI threshold; and
the NDP sent again by the initiator is not processed, in response to the CSI variation not exceeding the CSI threshold. That is, the subsequent NDP sent by the initiator is ignored, and the CSI measurement value is not reported to the initiator, thereby saving signaling messages.

According to embodiments of the present disclosure, the responder receives the target radio frame, which includes the Channel State Information (CSI) threshold. The CSI threshold is configured for the responder to determine, based on the CSI threshold, whether to send the CSI measurement value to the initiator. Embodiments of the present disclosure provide a method for indicating the CSI threshold in the WLAN sensing procedure.

Based on the same principles as the methods provided in the above, embodiments of the present disclosure also provide a communication apparatus, which is applied to the initiator. As shown in FIG. 7, the apparatus includes a determination module 701 and a sending module 702.

The determination module 701 is configured to determine the target radio frame. The target radio frame includes a Channel State Information (CSI) threshold, and the CSI threshold is configured for a responder to send a CSI measurement value to an initiator based on the CSI threshold.

In some embodiments, as shown in FIGS. 2 to 4, a WLAN sensing architecture and a WLAN sensing procedure in which the communication method provided in embodiments of the present disclosure is applied are first introduced, the specific contents of which can be found in the aforementioned embodiments and will not be repeated here. In the WLAN sensing procedure, the initiator determines the target radio frame and carries the CSI threshold in the target radio frame. The CSI threshold is the threshold for measuring the CSI variation in the channel. The CSI variation refers to the difference between the currently measured CSI and the previously measured CSI. The CSI threshold is configured for the responder to send the CSI measurement value to the initiator based on the CSI threshold. After receiving the target radio frame, the responder obtains the CSI threshold in the target radio frame and determines, based on the data relationship between the current CSI variation and the CSI threshold, whether to report CSI to the initiator. In some embodiments, if the current CSI variation does not exceed the CSI threshold, the responder may not report CSI, thereby saving signaling messages.

In some embodiments, the target radio frame can be a trigger frame or a message frame in the sensing measurement process. The CSI threshold can come from an upper layer application, for example, the CSI threshold is directly indicated to the initiator by the upper layer.

The sending module 702 is configured to send the target radio frame.

The initiator sends the target radio frame to the responder, so that the responder can determine, based on the CSI threshold in the target radio frame, whether to report CSI.

In some embodiments, the target radio frame includes at least one of a trigger frame, a message frame for sensing session establishment, and a message frame for sensing measurement establishment.

In some embodiments of the present disclosure, the CSI threshold includes a first CSI threshold corresponding to a sensing session, or a second CSI threshold corresponding to a measurement process, or a third CSI threshold corresponding to a measurement instance.

In some embodiments, in case that the CSI threshold includes the first CSI threshold, the target radio frame includes the message frame for sensing session establishment.

In some embodiments, in case that the CSI threshold includes the second CSI threshold, the target radio frame includes the message frame for sensing session establishment.

In the message frame for sensing session establishment, the second CSI threshold corresponds to a measurement process identifier.

In some embodiments, in case that the CSI threshold includes the third CSI threshold, the target radio frame includes the message frame for sensing measurement establishment.

In the message frame for sensing measurement establishment, the third CSI threshold corresponds to the combination of the measurement process identifier and the measurement instance identifier.

In some embodiments, the apparatus further includes a CSI receiving module.

The CSI receiving module is configured to receive the CSI measurement value sent by the responder. The CSI measurement value is sent by the responder to the initiator in response to the measured CSI variation exceeding the CSI threshold.

The communication apparatus provided by the present disclosure determines the target radio frame through the determination module 701, and sends the target radio frame to the responder through the sending module 702. The target radio frame includes the Channel State Information (CSI) threshold, which is configured for the responder to determine, based on the CSI threshold, whether to send the CSI measurement value to the initiator.

Embodiments of the present disclosure also provide a communication apparatus, which is applied to the responder. As shown in FIG. 8, the apparatus includes a receiving module 801 and a processing module 802.

The receiving module 801 is configured to receive a target radio frame and obtain a Channel State Information (CSI) threshold carried in the target radio frame.

In some embodiments, as shown in FIGS. 2 to 4, a WLAN sensing architecture and a WLAN sensing procedure in which the communication method provided in embodiments of the present disclosure is applied are first introduced, the specific contents of which can be found in the aforementioned embodiments and will not be repeated here. In the WLAN sensing procedure, the responder receives the target radio frame and obtains the CSI threshold carried in the target radio frame. The CSI threshold is the threshold for measuring the CSI variation in the channel. The CSI variation refers to the difference between the currently measured CSI and the previously measured CSI. The CSI threshold is configured for the responder to send the CSI measurement value to the initiator based on the CSI threshold. After receiving the target radio frame, the responder obtains the CSI threshold in the target radio frame.

The processing module 802 is configured to perform a processing operation based on a CSI variation and the CSI threshold.

After obtaining the CSI threshold, the responder determines, based on the data relationship between the current CSI variation and the CSI threshold, whether to report the CSI measurement value to the initiator. In some embodiments, if the current CSI variation does not exceed the CSI threshold, the responder may not report CSI, thereby saving signaling messages. In response to the measured CSI variation exceeding the CSI threshold, the responder sends the CSI measurement value to the initiator.

In some embodiments, the target radio frame includes at least one of a trigger frame, a message frame for sensing session establishment, and a message frame for sensing measurement establishment.

In some embodiments of the present disclosure, the CSI threshold includes a first CSI threshold corresponding to a sensing session, or a second CSI threshold corresponding to a measurement process, or a third CSI threshold corresponding to a measurement instance.

In some embodiments, in case that the CSI threshold includes the first CSI threshold, the target radio frame includes the message frame for sensing session establishment.

In some embodiments, in case that the CSI threshold includes the second CSI threshold, the target radio frame includes the message frame for sensing session establishment.

In the message frame for sensing session establishment, the second CSI threshold corresponds to a measurement process identifier.

In some embodiments, in case that the CSI threshold includes the third CSI threshold, the target radio frame includes the message frame for sensing measurement establishment.

In the message frame for sensing measurement establishment, the third CSI threshold corresponds to the combination of the measurement process identifier and the measurement instance identifier.

In some embodiments, the processing module 802 further includes a determination submodule, a first processing submodule, and a second processing submodule.

The determination submodule is configured to receive a null data packet (NDP) sent by the initiator, measure the CSI, and determine the CSI variation.

The first processing submodule is configured to send, in response to the CSI variation exceeding the CSI threshold, the CSI measurement value to the initiator.

The second processing submodule is configured to not process, in response to the CSI variation not exceeding the CSI threshold, the NDP sent again by the initiator.

According to embodiments of the present disclosure, the receiving module 801 receives the target radio frame, which includes the Channel State Information (CSI) threshold. The CSI threshold is used by the processing module 802 to determine, based on the CSI threshold, whether to send the CSI measurement value to the initiator. Embodiments of the present disclosure provide a method for indicating the CSI threshold in the WLAN sensing procedure.

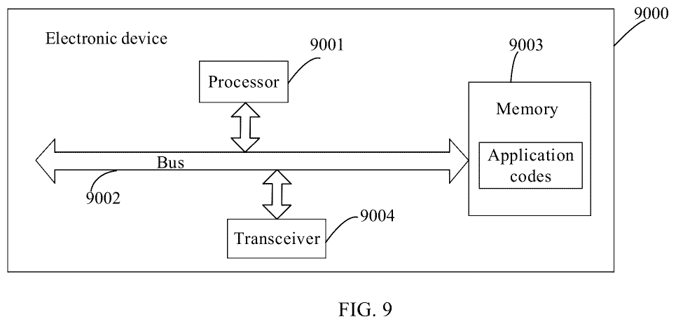

In some embodiments, embodiments of the present disclosure also provide an electronic device, as shown in FIG. 9. The electronic device 9000 shown in FIG. 9 can be a server, including a processor 9001 and a memory 9003. In some embodiments, the processor 9001 is connected to the memory 9003, for example, through a bus 9002. In some embodiments, the electronic device 9000 can further include a transceiver 9004. It should be noted that in practical applications, the transceiver 9004 is not limited to one transceiver, and a structure of the electronic device 9000 does not constitute a limitation to embodiments of the present disclosure.

The processor 9001 can be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various exemplary logical blocks, modules, and circuits described in conjunction with the present disclosure. The processor 9001 can also be a combination of computing functions, such as a combination containing one or more microprocessors, a combination containing the DSP and the microprocessor, etc.

The bus 9002 can include a path for delivering information between the aforementioned components. The bus 9002 can be a PCI (Peripheral Component Interconnect) bus or an EISA (Extended Industry Standard Architecture) bus, etc. The bus 9002 can be divided into an address bus, a data bus, a control bus, etc. For ease of representation, only one thick line is used in FIG. 9, but it does not mean that there is only one bus or one type of bus.

The memory 9003 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory), or other optical disk storage devices, optical disc storage devices (including compressed discs, laser discs, optical discs, digital universal discs, Blu-ray discs, etc.), magnetic disk storage media or other magnetic storage devices, or any other media that can be used to carry or store desired program codes in the form of instructions or data structures and can be accessed by computers, but not limited to this.

The memory 9003 is used to store application program codes for implementing the present disclosure, and the execution of the codes is controlled by the processor 9001. The processor 9001 is used to execute the application program codes stored in the memory 9003 to implement the methods provided in the aforementioned method embodiments.

In some embodiments, the electronic device includes but is not limited to mobile phones, laptops, digital broadcasting receivers, PDAs (Personal Digital Assistant), PADs (tablet), PMPs (Portable Multimedia Player), in-vehicle terminals (such as in-vehicle navigation terminals), and fixed terminals such as digital TVs, desktop computers, and so on. The electronic device shown in FIG. 9 is only an example and should not impose any limitations on the functionality and the use scope of embodiments of the present disclosure.

The server provided in the present disclosure can be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, as well as big data and artificial intelligence platform. The terminal can be smartphone, tablet, laptop, desktop computer, smart speaker, smartwatch, etc., but is not limited to this. The terminal and the server can be directly or indirectly connected through wired or wireless communication methods, and the present disclosure is not limited here.

Embodiments of the present disclosure provide a computer-readable storage medium on which a computer program is stored. When the computer program is running on a computer, enables the computer to implement the corresponding content of the aforementioned method embodiments.

It should be understood that although the various steps in the flowchart in the drawings are displayed in sequence indicated by arrows, these steps are not necessarily executed in the order indicated by the arrows. Unless explicitly stated in the article, the execution of these steps does not have strict order restrictions and can be carried out in other orders. Moreover, at least a portion of the steps in the flowchart of the drawings can include multiple sub steps or stages, which may not necessarily be completed at the same time, but may be executed at different times, and their execution order may not necessarily be in sequence, but may rotate or alternate with at least a portion of other steps or sub steps or stages.

It should be noted that the computer-readable medium mentioned in the present disclosure can be a computer-readable signal medium, a computer-readable storage medium, or any combination of the two. The computer-readable storage medium can be, but is not limited to, an electrical, magnetic, optical, electromagnetic, infrared, or semiconductor system, apparatus, or device, or any combination thereof. More specific examples of the computer-readable storage medium can include, but are not limited to: electrical connections with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the present disclosure, a computer-readable storage medium can be any tangible medium containing or storing a program, which can be used by an instruction execution system, apparatus, or device, or in combination with it. In the present disclosure, the computer-readable signal medium can include data signals propagated in the baseband or as part of the carrier wave, which carry computer-readable program codes. This type of transmitted data signal can take various forms, including but not limited to electromagnetic signals, optical signals, or any suitable combination of the above. The computer-readable signal medium can also be any computer-readable medium other than a computer-readable storage medium, which can send, propagate, or transmit programs for use by an instruction execution system, apparatus, or device, or in combination with it. The program code contained on computer-readable medium can be transmitted using any appropriate medium, including but not limited to: wires, optical cables, RF (radio frequency), etc., or any suitable combination of the above.

The above-mentioned computer-readable medium can be included in the electronic device mentioned above. It can also exist separately without being assembled into the electronic device.

The above-mentioned computer-readable medium carries one or more programs, which, when executed by the electronic device, cause the electronic device to implement the methods shown in the above embodiments.

According to one aspect of the present disclosure, a computer program product or computer program is provided, including computer instructions stored in a computer-readable storage medium. The processor of a computer device reads the computer instruction from the computer-readable storage medium, executes the computer instructions, and causes the computer device to implement the communication methods provided in the various embodiments mentioned above.

The computer program codes for implementing the operations disclosed herein can be written in one or more programming languages or combinations thereof, including object-oriented programming languages such as Java, Smalltalk, C++, and conventional procedural programming languages such as C or similar programming languages. The program codes can be completely executed on the user's computer, partially executed on the user's computer, executed as an independent software package, partially executed on the user's computer and partially executed on a remote computer, or completely executed on the remote computer or a server. In the case where remote computers are involved, the remote computer can be connected to the user computer through any type of networks, including local area networks (LAN) or wide area networks (WAN), or can be connected to an external computer (such as connected via the internet provided by internet service providers).

The flowchart and block diagram in the drawings illustrate the possible architectures, functions, and operations of the systems, methods, and computer program products according to various embodiments of the present disclosure. Each box in a flowchart or block diagram can represent a module, a program segment, or a part of codes that contain one or more executable instructions for implementing a specified logical function. It should also be noted that in some embodiments, the functions indicated in the box can also occur in a different order than those indicated in the drawings. For example, two consecutive boxes can actually be executed in basic parallel order, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in embodiments of the present disclosure can be implemented through software or hardware. In some embodiments, the name of the module does not constitute a limitation on the module itself in a certain situation. For example, module A can also be described as “module A used to perform operation B”.

The above description is only for embodiments of the present disclosure and an explanation of the technical principles involved. Those skilled in the art should understand that the scope of the present disclosure is not limited to technical solutions formed by specific combinations of the technical features mentioned above, and should also cover other technical solutions formed by arbitrary combinations of the technical features mentioned above or their equivalent features without departing from the concept disclosed. For example, a technical solution formed by replacing the above features with technical features with similar functions disclosed (but not limited to) in the present disclosure.

1. A communication method, performed by an initiator, the method comprising:
determining a target radio frame, wherein the target radio frame comprises a Channel State Information (CSI) threshold, and the CSI threshold is configured for a responder to send a CSI measurement value to the initiator based on the CSI threshold; and
sending the target radio frame.

2. The communication method according to claim 1, wherein the target radio frame comprises at least one of: a trigger frame, a message frame for sensing session establishment, a message frame for sensing measurement establishment.

3. The communication method according to claim 2, wherein the CSI threshold comprises:
a first CSI threshold corresponding to a sensing session; or
a second CSI threshold corresponding to a measurement process; or
a third CSI threshold corresponding to a measurement instance.

4. The communication method according to claim 3, wherein in case that the CSI threshold comprises the first CSI threshold, the target radio frame comprises the message frame for sensing session establishment.

5. The communication method according to claim 3, wherein in case that the CSI threshold comprises the second CSI threshold, the target radio frame comprises the message frame for sensing session establishment; and
in the message frame for sensing session establishment, the second CSI threshold corresponds to a measurement process identifier.

6. The communication method according to claim 3, wherein in case that the CSI threshold comprises the third CSI threshold, the target radio frame comprises the message frame for sensing measurement establishment; and
in the message frame for sensing measurement establishment, the third CSI threshold corresponds to a combination of a measurement process identifier and a measurement instance identifier.

7. The communication method according to claim 1, further comprising:
receiving a CSI measurement value sent by the responder, wherein the CSI measurement value is sent by the responder to the initiator in response to a measured CSI variation exceeding the CSI threshold.

8. A communication method, performed by a responder, the method comprising:
receiving a target radio frame to obtain a Channel State Information (CSI) threshold carried in the target radio frame; and
performing a processing operation based on a CSI variation and the CSI threshold.

9. The communication method according to claim 8, wherein the target radio frame comprises at least one of a trigger frame, a message frame for sensing session establishment, and a message frame for sensing measurement establishment.

10. The communication method according to claim 9, wherein the CSI threshold comprises:
a first CSI threshold corresponding to a sensing session; or
a second CSI threshold corresponding to a measurement process; or
a third CSI threshold corresponding to a measurement instance.

11. The communication method according to claim 10, wherein in case that the CSI threshold comprises the first CSI threshold, the target radio frame comprises the message frame for sensing session establishment.

12. The communication method according to claim 10, wherein in case that the CSI threshold comprises the second CSI threshold, the target radio frame comprises the message frame for sensing session establishment; and
in the message frame for sensing session establishment, the second CSI threshold corresponds to a measurement process identifier.

13. The communication method according to claim 10, wherein in case that the CSI threshold comprises the third CSI threshold, the target radio frame comprises the message frame for sensing measurement establishment; and
in the message frame for sensing measurement establishment, the third CSI threshold corresponds to a combination of a measurement process identifier and a measurement instance identifier.

14. The communication method according to claim 8, wherein
performing the processing operation based on the CSI variation and the CSI threshold comprises:
receiving a null data packet (NDP) sent by an initiator, measuring the CSI, and determining the CSI variation;
sending, in response to the CSI variation exceeding the CSI threshold, a CSI measurement value to the initiator; and
ignoring, in response to the CSI variation not exceeding the CSI threshold, the NDP sent again by the initiator.

15-16. (canceled)

17. An electronic device comprising a memory, a processor, and a computer program stored on the memory and executable by the processor, wherein the processor is configured to:
determine a target radio frame, wherein the target radio frame comprises a Channel State Information (CSI) threshold, and the CSI threshold is configured for a responder to send a CSI measurement value to the initiator based on the CSI threshold; and
send the target radio frame.

18. A non-transitory computer-readable storage medium having a computer program stored thereon, which when executed by a processor, the method according to claim 1 is caused to be implemented.

19. An electronic device comprising a memory, a processor, and a computer program stored on the memory and executable by the processor, wherein the processor is configured to execute the computer program to implement the method according to claim 8.

20. A non-transitory computer-readable storage medium having a computer program stored thereon, which when executed by a processor, the method according to claim 8 is caused to be implemented.

21. The communication method according to claim 1, wherein the CSI threshold is received from an upper layer application.

22. The communication method according to claim 8, wherein the CSI variation is determined based on difference between currently measured CSI and previously measured CSI.
